(19) United States
(12) Patent Application Publication
(10) Pub. No.: US 2013/0147787 A1
(43) Pub. Date: Jun. 13, 2013

(54) Systems and Methods for Transmitting Visual Content

(71) Applicants: Sergey Ignatchenko, Innsbruck (AT); Dmytro Ivanchykhin, Kiev (UA)

(72) Inventors: Sergey Ignatchenko, Innsbruck (AT); Dmytro Ivanchykhin, Kiev (UA)

(21) Appl. No.: 13/323,163

(22) Filed: Dec. 12, 2011

(51) Int. Cl. G09G 5/377; G06T 15/00

(52) U.S. Cl. 345/419; 345/629

(57) ABSTRACT

The systems, methods and apparatuses described herein permit the transmittal of digital media content from a source device to a target device. A source device represents media content as discrete elements, wherein each element embodies a separate layer of the media content. The source device creates visual objects corresponding to the elements, wherein each visual object includes one or more attributes including, but not limited to, a Z-order designation designating the element's layer with respect to the other elements of the media content. Each visual object can be managed and updated independently. A target receives the visual objects, reconstructs the media content, and displays the media content on a display.

### FIELD

The present invention relates to systems, methods and apparatuses for transmitting digital media content from one device to another over a limited bandwidth data connection.

### BACKGROUND

A variety of smart phone applications are available online, and the market for them is growing. Additionally, vast amounts of media-rich content are available online and on permanent storage such as DVDs and CDs, including music, movies, video clips, web pages, video games and the like. As portable electronic devices such as smart phones, personal digital assistants and tablet computers have become more popular and capable, media content is increasingly downloaded to such devices and processed by applications residing on those devices. Such devices, despite their increased CPU capabilities, still have limited system resources and limited user playback interfaces, with small screens and limited battery power. These devices are often insufficient to provide the best possible user experience—for example, the screen may be too small for a user to be able to watch the video comfortably.

In such cases, users may prefer to view the media content generated, stored or downloaded to their portable electronic device on a larger electronic device, such as a television. However, traditional systems do not allow for the easy exchange of digital media content from an application running on a small electronic device such as a smart phone to a television. For example, a DRM-protected video may be downloaded to a smart phone having a Blu-ray software application capable of opening and playing back the video. Transmitting the video from the smart phone for playback on a television presents significant problems, because solutions currently known in the art have significant disadvantages.

A first possible approach may be to transmit the entire contents of the Blu-ray file from the smart phone to a television and to let all of the related processing occur entirely on the television. This solution is not ideal for several reasons. First, this approach has significant pricing implications because the complexity of the Blu-ray standard makes it very expensive to keep, maintain, and update a full-scale Blu-ray player within every television set. Another problem with this approach is that for DRM-protected media it is preferable not to release all of the media in its entirety, but rather only what is absolutely necessary to third-party (and potentially untrusted) devices. Further, with such an approach, the current state of Blu-ray playback (which can be complicated, and may include, for example, the state of a Java Virtual Machine) would reside within the television. In the event the smart phone were disconnected from the television, moving the state of the Blu-ray playback back to the smart phone could be complicated and time-consuming (and, in some cases, even unfeasible). Additionally, with such an approach, transmitting the entire contents of the Blu-ray file could cause significant delays before playback can start.

A second possible approach may be to perform all the processing associated with the rendering of the media content on the smart phone, and to simply pass already-rendered screens to the television set. This approach also has significant drawbacks, because the transfer of rendered video at 25 frames per second, with each frame containing 1920×1080 pixels of uncompressed video content (also known as “1080p”) could require more than 1 GBit/s of bandwidth. Known wireless communications technologies (e.g., WiFi, cellular, Bluetooth, etc.) traditionally do not provide this amount of bandwidth. In addition, the CPU power required to perform full-scale rendering of the 1080p video stream would likely be either beyond the smart phone CPU's processing capability, or at the very least, would cause high energy consumption and thereby significantly reduce the battery life of such a smart phone.

What is needed is a system in which a small electronic device can be used to run applications which can transmit compressed video data (i.e. visual and/or audio data) to a device having more system resources, such as a TV or a set-top box. The target device may then be capable of performing decompression and presenting the data to the user.

### SUMMARY

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

The systems, methods and apparatuses of the present disclosure describe how different applications running on a source device (such applications being, for example, media players, web browsers, or video games) may transmit media content to be displayed on the screen of another device, when the bandwidth between devices may be limited and the target device may not have the capability of running arbitrary applications. For example, a person may want to transmit a web page or a video clip from his smart phone to his television for the purpose of viewing the web page or video clip on the larger television screen.

One or more applications running on the source device may represent media content as a collection of elements representing different aspects of the media content. For example, a web page having text, graphics and an embedded video, wherein the video has subtitles, may be represented as three elements: (1) the static text and/or graphics of the web page; (2) the embedded video; and (3) the subtitles to be overlaid on the video. Each element may embody a separate layer of the media content. In other words, when reconstructing the media content on the target device, the static text and/or graphics should be displayed first (i.e., layer 1), then the video (layer 2), and then the subtitles (layer 3). This concept is referred to herein as Z-ordering.

The application may create an object corresponding to each such element, where each object contains the actual visual content corresponding to the element (e.g., the text and/or graphics, the video stream, or the subtitles), an indicator as to where to place the element on the target device display, a Z-order, and a unique identifier for the object.

Depending on the capabilities of the target device, the source device may perform certain pre-processing of each element. For example, a target device such as a television may not be capable of rendering a web page. In such a case, an application running on the source device may convert the static text and/or graphics of the web page to an image, create an object for that image, and transmit the image object to the target device. If the web page also includes embedded video, the application on the source device may create an object for the compressed video stream and transmit the video object to the target device. The apparatuses, methods and systems described herein further allow the transmitting and updating of each of such objects separately. For example, the frames of a video object may be continually updated without requiring a change in the image object corresponding to the web page background.

Thus, source devices may efficiently transmit media content to target devices keeping the amount of data transmitted and the amount of computations necessary to prepare such data minimal. In many practical cases, this provides significant advantages over current solutions. For example, if an individual were to run a Blu-ray player application on a smart phone with the intention of showing an interactive Blu-ray movie on a television screen, the current state of the art—rendering the movie on the side of the smart phone—would require about 1 GBit/s bandwidth. Even if real-time intra-frame lossy compression were added, reducing the overall quality of the movie, the system would still require at least around 100-200 MBit/s bandwidth. On the other hand, transmission of a Blu-ray movie according to the present disclosure may allow the movie to fit into 20-25 MBit/s of bandwidth without any reduction in quality (as compared to the quality of the Blu-ray media source).

For accomplishing the foregoing and related ends, certain illustrative aspects of the systems, apparatuses, and methods according to the present invention are described herein in connection with the following description and the accompanying figures. These aspects are indicative, however, of but a few of the various ways in which the principles of the invention may be employed and the present invention is intended to include all such aspects and their equivalents. Other advantages and novel features of the invention may become apparent from the following detailed description when considered in conjunction with the figures.

### BRIEF DESCRIPTION OF THE DRAWINGS

FIG. 1a-1c illustrate the concept of Z-order and one example of how media content may be represented as different elements.

FIG. 2 is an exemplary block diagram of a system according to the present disclosure.

FIGS. 3a and 3b are logical diagrams illustrating objects and their associated processing according to one embodiment of the present disclosure.

FIGS. 4a through 8c illustrate various exemplary methods for transmitting media content from a source device to a target device according to the present disclosure.

### DETAILED DESCRIPTION

In the following detailed description, numerous specific details are set forth in order to provide a thorough understanding of the invention. In other instances, well known structures, interfaces, and processes have not been shown in detail in order not to unnecessarily obscure the invention. However, it will be apparent to one of ordinary skill in the art that those specific details disclosed herein need not be used to practice the invention and do not represent a limitation on the scope of the invention, except as recited in the claims. It is intended that no part of this specification be construed to effect a disavowal of any part of the full scope of the invention. Although certain embodiments of the present disclosure are described, these embodiments likewise are not intended to limit the full scope of the invention.

The systems, methods and apparatuses described herein permit transmission of digital media content, such as a digital movie, from one device to another, over a limited data connection. For example, a person may want to transmit a movie from his smart phone to his television for the purpose of viewing the movie on the larger television screen. “Media content” as used throughout refers to any visual data or visual representation of information such as, but not limited to, still images, pictures or graphics, text, movies, video clips, two-dimensional animation, web pages, video games, three-dimensional images or video (including three-dimensional animation), or any combination of the foregoing.

One technique by which the present disclosure may minimize the amount of data transferred from one device to another is by representing media content as a collection of visual elements, and then using the concept of Z-ordering to stack these visual elements as different “layers.”

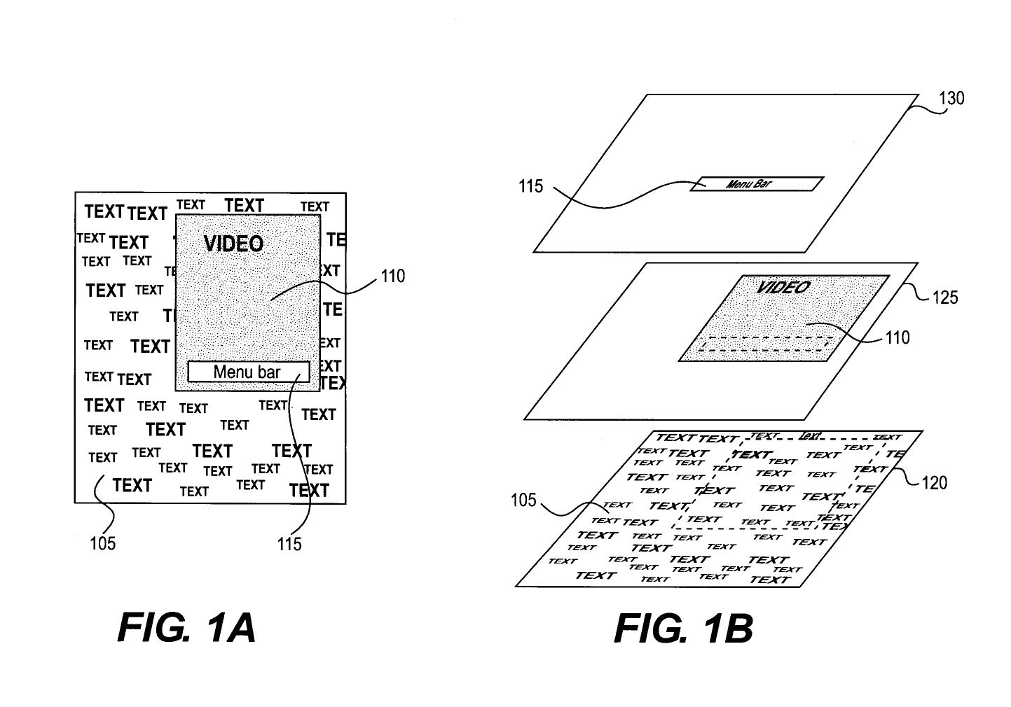

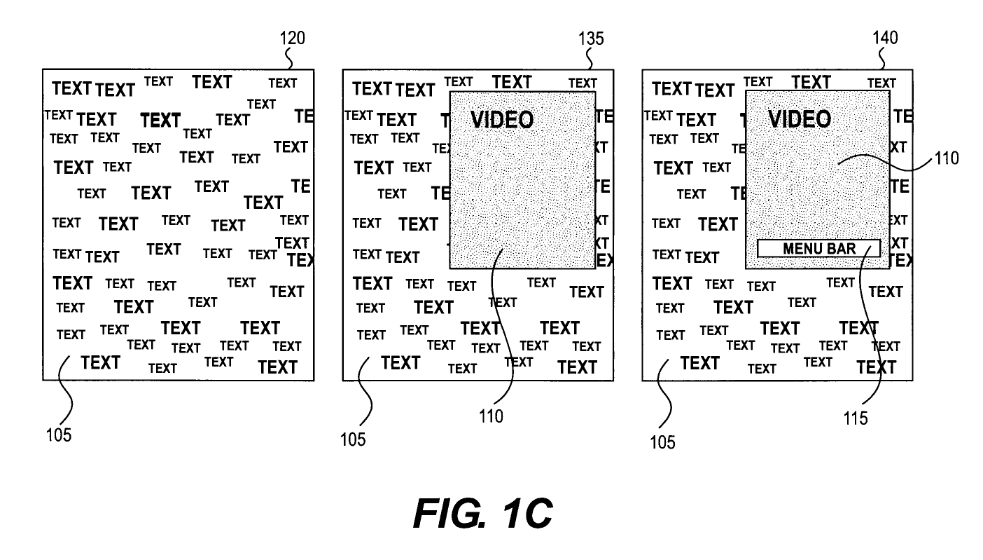

For example, FIGS. 1a-1c show an exemplary web page 100 which might be viewed by a user using a browser on his smart phone. As shown in FIG. 1a, a web page 100 may show a video 110 with an overlaid menu or progress bar 115 against a “static” background such as text and/or graphics (i.e., these items do not change once the web page is rendered on the monitor) 105. The video 110 may, for example, be an H.264/MPEG4 Part 10 Codec (also known as “Advanced Video Coding” or “H.264 AVC”) video stream, and the menu bar 115 may be the menu portions of a Flash object.

The web page 100 shown on FIG. 1a readily lends itself to representation as three visual elements—(1) the static background 105, (2) the embedded video 110, and (3) the menu/progress bar 115. Each of these visual elements is distinct, and, most likely, is maintained independently of the other elements, e.g., it may be updated on the webpage without regard to any of the other elements. For example, when the video 110 is updated, e.g., a new frame is displayed, there is no need to update the background 105; similarly, the menu/progress bar 115 may be updated somewhat regularly, but not as frequently as the video 110 needs to be updated.

Many other applications and content formats readily lend themselves to representation as a collection of visual elements, each element embodying a separate or different layer of the overall media content. For example, the MPEG-4 format encapsulates both video and subtitles as discrete elements within the same container. Therefore, an application performing MPEG-4 playback can extract video information and subtitle information separately and form two separate layers (i.e., one for video and one for subtitles).

The operating system may perform or assist in performing the recognizing and organizing of visual elements. For instance, if an application issues a function call to the operating system to play a video (in Microsoft Windows it can be, for example, a call of the method System.Windows.Controls.MediaElement.Play( )), then in addition to any other processing of that method call, the operating system could interpret that method call (provided that the target device supports the video encoding used in the file, which was specified as one of the properties of System. Windows. Controls.MediaElement), as requiring the creation of a separate video object with its own position and Z-order corresponding to the position and Z-order of the window. After the video object is transmitted to the target device, the operating system (or other application on the source device) may transmit additional encoded frame data to the target device as updates. Accordingly, the source device avoids having to decode the frames before transmitting the frame updates to the target device and the overall system requires a lesser amount of bandwidth to transmit the frame data from the source device to the target device (as compared to the situation in which the frames are decoded before being transmitted by the source device).

Modern graphical operating systems typically contain many application programming interface (API) calls that facilitate the creation and/or playback of still image, video, 3D, etc. visual depictions. It is to be understood that many (if not all) of these API calls can be treated in a manner similar to that described above. Additionally, if necessary or desirable, new high-level APIs to allow similar processing may be added to the operating system and/or programming libraries.

FIG. 1b shows how these visual elements may embody different “layers”: the lowest layer 120 comprising the background and text 105, the middle layer 125 comprising video 110, and the highest layer 130 comprising a menu and/or progress bar 115.

Finally, FIG. 1c demonstrates one method by which the initial page 100 can be redrawn by consecutively drawing layers 120, 125, 130 from the lowest to the highest such as, for example, on a television. First, only the lowest layer 120 is drawn. Then the middle layer 125 is drawn over the bottom layer 120, this combination shown as 135. Finally, the highest layer 130 is drawn over both the bottom and middle layers, shown as combination 140. It should be noted that this way of combining elements is presented mostly for illustrative purposes, and that in many cases alternative ways of combining (but achieving the same visual result) can be used.

Use of Z-layers in this manner means that the amount of information which is necessary to reproduce a visual representation of the web page 100 can be limited to (1) a single (still) image containing text and/or graphics 105, (2) a sequence of frames representing video 110, and (3) one or more (potentially partially transparent) images representing the states of the menu and/or progress bar 115. Moreover, each of these components can be compressed using commonly known suitable methods (for instance, PNG for still images and H.264 AVC or Motion JPEG for video).

In addition, as is apparent from the foregoing example, the type of visual elements in each of the different Z-layers can be different, such as, for example, still images, videos, two-dimensional (2D) animated objects, or even three-dimensional (3D) elements, such as 3D objects or 3D animations. Still images may be stored and/or transmitted as ordinary or partially transparent bitmaps so as to allow for the overlay of different shapes. In one embodiment, this may be implemented by adding an alpha-channel to an image bitmap. For example, a subtitle may be represented by a partially transparent image. The subtitle may be represented as a rectangular bitmap, such that the alpha-channel indicates that all pixels representing text are to be rendered as opaque (i.e., opacity=100%), some pixel(s) on the border of the text can be partially transparent (i.e., 0<opacity <100%), and all other pixels may be completely transparent (i.e., opacity=0). Images may further be compressed by an image compression method, like JPEG or PNG, if necessary (while JPEG does not support alpha channels directly, they can be simulated, or alternatively, JPEG can be used for non-transparent images). Video data may be stored and/or transmitted as video streams, and may be compressed using a video compression algorithm like H.264 AVC or WMV9.

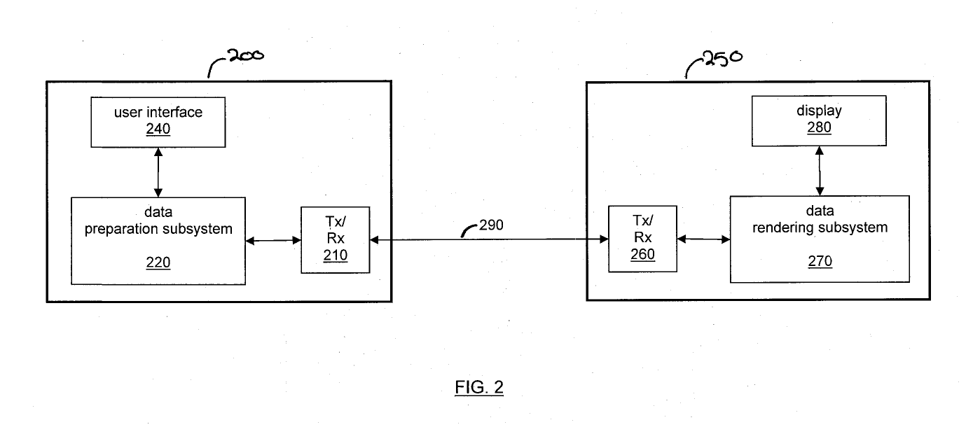

FIG. 2 is a simplified block diagram of an exemplary system according to the present disclosure. As shown on FIG. 2, a system according to the present disclosure may first comprise a source device 200, such as a smart phone, personal digital assistant, tablet computer or other portable electronic device. It is to be understood, however, that the source device is not limited to a portable electronic device. The source device may be any type of electronic device capable of operating in the manner discussed herein including, but not limited to, a server computer or other computing device with or without a user interface.

The system may further comprise a target device 250, such as a television or a computer monitor, or a combination of devices, like a set-top box, a digital video recorder, a console or a Blu-ray player connected to a television, as discussed in more detail below.

A source device 200 may comprise one or more communication ports 210 enabling it to communicate with other electronic devices, including but not limited to the target device 250. For example, in addition to transmitting media content to the target device 250, the source device 200 may use these communication ports 210 to access, download and/or copy media content from the Internet, a computer system, or some form of storage such as a flash drive. The one or more communication ports 210 may be comprised of any combination of hardware and/or software appropriate for establishing and maintaining two-way communications, including, but not limited to, wired protocols such as serial, parallel, coaxial and USB, and wireless protocols such as Bluetooth, near field communications, infrared, IEEE 802.11 and cellular connectors. It is to be understood, however, that these references are merely exemplary, and the invention is not limited to any specific form of communications technology.

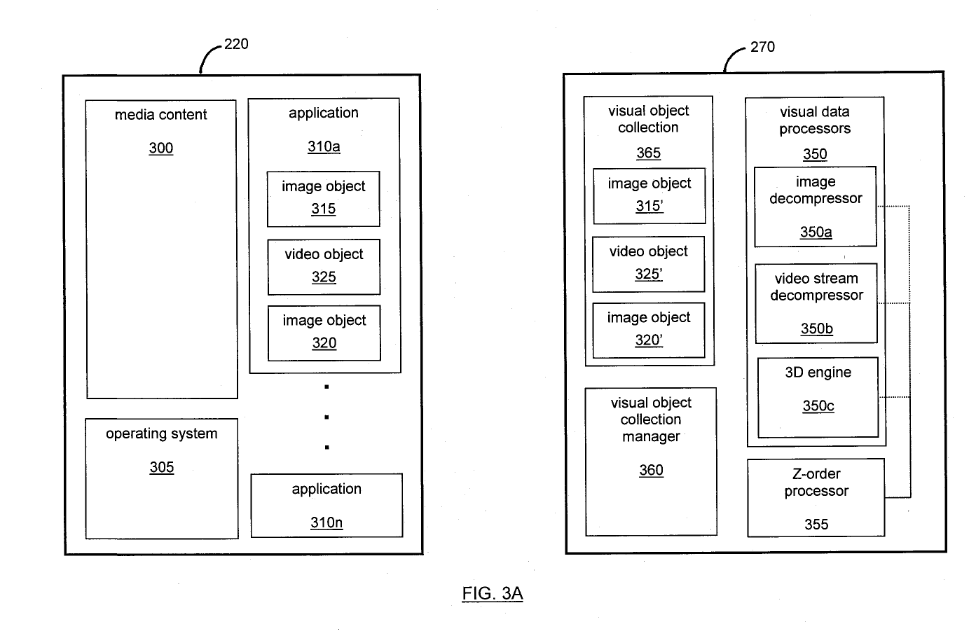

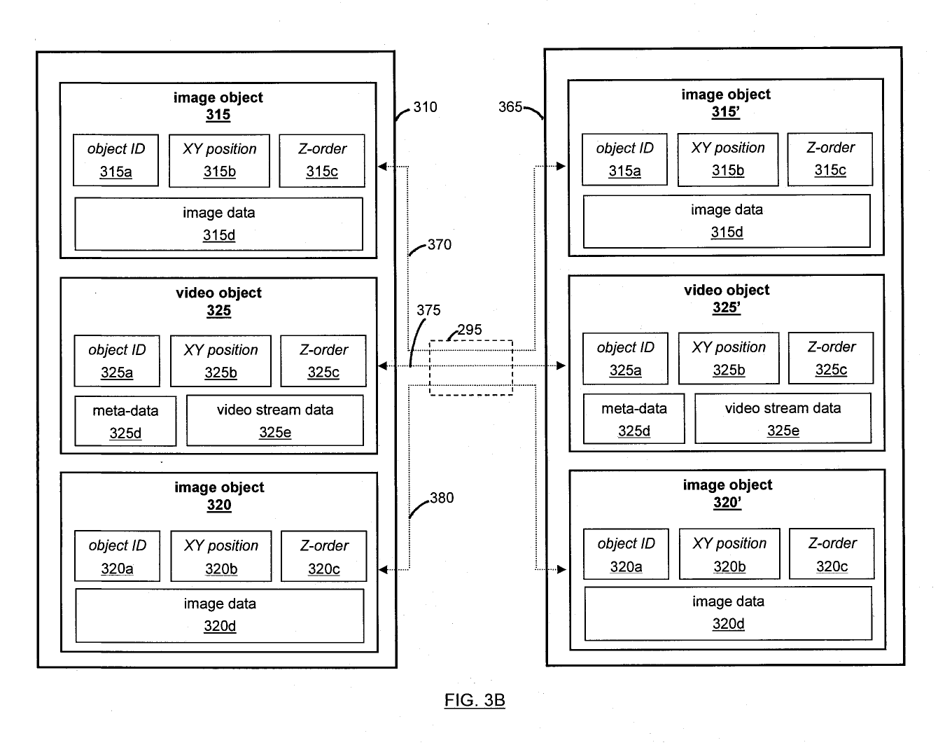

The source device 200 may also comprise a data preparation subsystem 220. The data preparation subsystem 220 may receive and store media content acquired by the user and prepare such media content for transmission to a target device 250 in accordance with the methods described herein. One having ordinary skill in the art will understand that the data preparation subsystem 220 may be implemented in hardware, software, or some combination thereof, as may be dictated by the specific nature of the source device 200, the type of applications to be performed by the source device 200, and any other constraints of the overall system. One logical illustration of one embodiment of a data preparation subsystem 220 is described in more detail with respect to FIGS. 3a and 3b below. It is to be understood, however, that the invention is not limited to this particular embodiment and other implementations of the data preparation subsystem 220 are also within the scope of the present disclosure.

In some embodiments, the source device 200 may further comprise one or more user interfaces 240, allowing a user to interact with the source device 200. For example, the user may use the user interface 240 to initiate the preparation and transmission of media content to the target device 250. In such an embodiment, the source device 200 may include a display (which may or may not be touch sensitive), and the user may be able to transmit the entire contents of the screen to the target device 250. In another embodiment, the user interface 240 may also have a mechanical or virtual keypad. In this case, for example, the user may use the user interface 240 to view a list or other representation of the media content stored on the device, and then select a specific item for transmission to the target device 250. Other embodiments may not require a user interface 240, and an operating system or applications running on the source device 200 may initiate the preparation and transmission of media content to the target device 250 without requiring user input through a user interface.

Although not shown on FIG. 2, one having ordinary skill in the art will understand that the source device 200 may include one or more additional component parts, such as additional processors, memory, other data storage units, data transmission lines, communication ports and/or other specialized circuitry.

Also as shown on FIG. 2, the target device 250 may comprise one or more communication ports 260. These communication ports 260 may be comprised of any combination of hardware and/or software appropriate for establishing and maintaining two-way communications, and which are capable of communicating with the communications port of the source device 200, including, but not limited to, wired protocols such as serial, parallel, coaxial and USB, and wireless protocols such as Bluetooth, near field communications, infrared, IEEE 802.11 and cellular connectors. It is to be understood, however, that these references are merely exemplary, and the invention is not limited to any specific form of communications technology.

The target device 250 may further comprise a data rendering subsystem 270 capable of receiving transmitted data, instructions and updates from the communications port 260 and preparing the received data for presentation to a user of the target device 250 in accordance with the instructions. Such a data rendering subsystem 270 may be implemented as one or more general purpose processors, application-specific integrated circuits (ASICs), or any other suitable combination of hardware and/or software elements. One logical illustration of one embodiment of a visual data rendering subsystem 270 is described in further detail with respect to FIGS. 3a and 3b, below.

The target device 250 may further comprise one or more displays or screens 280 coupled to the data rendering subsystem 270 and capable of presenting media content to a user. A suitable display may be, for example, any form of two or three-dimensional electronic visual display including, but not limited to, a liquid crystal display (LCD), cathode ray tube (CRT) display, plasma display panel (PDP), laser display, holographic display or the like.

In order to transmit media content between the devices 200, 250, a communications link 290 may be established between the devices' respective communications ports 210, 260. Information to be displayed on the target device 250 can be transferred from the source device 200 over this communications link 290. Information received by the target device 250 may be processed by the data rendering subsystem 270, and then displayed on the display 280.

The foregoing discussion has generally described the elements of a target device 200 as if all components reside in the same unit, e.g., a television. However, it will be understood that the term “target device” 200 is not limited to a single device, but may refer to a combination of devices, such as a set-top box coupled to a television, or a video game console connected to a monitor, in which the devices taken together provide all of the components and functionality of a target device 200.

For example, many cable television providers in the United States require customers to connect a set-top box to their television sets in order to receive digital and/or high-definition video content from the provider. These set-top boxes are typically connected to the television by a hardwired connection, such as RCA cables, a coaxial cable, component video cables, or an HDMI cable. A set-top box configured according to the present disclosure may comprise a communications port 260 and a data rendering subsystem 270, while the television to which the set-top box is connected may provide the display 280; taken together, the set-top box and the television may comprise a target device 200. Information may be transmitted from the data rendering subsystem 270 for presentation on the television screen 280 using the existing connection between the set-top box and the television, e.g., an HDMI cable, without significant loss in signal quality.

FIGS. 3a and 3b are logical representations of one approach by which media content may be prepared on a source device 200, transmitted to a target device 250, and updated on the target device 250, each based on the Z-order concept described with respect to FIGS. 1a-1c. Continuing the same example, it may be desirable to transmit a web page—having, as shown in FIGS. 1a-1c, static text and/or graphics 105, an embedded video 110, and a menu/status bar 115—from the source device 200 to the target device 250, and to update the video 110 and status bar 115 accordingly.

FIG. 3a shows a logical block diagram of one implementation of the data preparation subsystem 220. As shown on FIG. 3a, the data preparation subsystem 220 may first comprise one or more media content (collectively designated as 300) acquired by a user, such as videos, e-books, video games, etc. This one or more media content 300 may be stored within a volatile memory (not shown) within the data preparation subsystem 220, such as within flash memory or RAM, or may reside within non-volatile storage, such as a hard disk drive, solid state disk, CD-ROM, DVD or Blu-ray disc, which has been coupled to the device 200. In another embodiment, this media content may be created “on the fly” by the source device 200.

The data preparation subsystem 220 may further comprise an operating system 305 and any number of application programs 310, such as web browsers, video games, Blu-ray players, etc. For purposes of illustration, applications are labeled on FIG. 3a as 310a through 310n, but it will be understood that there may be only one application or there may be several. In one embodiment, applications 310 and/or the operating system 305 running on the source device 200 may automatically request to show particular media content 300 on the display 280 of the target device 250 without input from the user, such as, for example, on recognizing the type of media content (e.g. Blu-ray) and the nearby presence of a television. In another embodiment, the user of a source device 200 may specifically select media content 300 for transmission to a target device 250.

One having ordinary skill in the art will understand that the logical blocks shown on FIG. 3a may be implemented in hardware, software, or some combination thereof, as may be dictated by the specific nature of the source device 200, the type of applications to be performed by the source device 200, and any other constraints of the overall system. It is to be understood, however, that the invention is not limited to this particular embodiment and other implementations of the data preparation subsystem 220 are also within the scope of the present disclosure.

In one embodiment, the data preparation subsystem 220 may create and manipulate “objects” corresponding to the visual elements embodying the media content 300. For example, an application 310a running on the source device 200 might create three objects corresponding to the three elements shown on the web page 100 of FIG. 1a—two image objects 315 and 320 and one video object 325.

As shown on FIG. 3b, each object—regardless of whether it contains image, video, or some other form of data—may possess multiple attributes, including but not limited to an object ID, an XY position, a Z-order number and object data.

An object ID (e.g., 315a, 320a and 325a on FIG. 3b) is a unique value for identifying an object with respect to other objects simultaneously present in the system. For example, each object might have a unique number, or alphanumeric string, with which it is associated. In one embodiment, it is the responsibility of the source device 200 to provide the object ID when initially sending the object to the target device 250. For example, to ensure uniqueness of the object ID, an application 310 may request that the operating system 305 issue an object ID. In another embodiment, such as, for example, if only a single application 310 is allowed to use the display 280 of the target device 250 at any time, an object ID may be generated by the application 310 itself. In another embodiment, an object ID may be generated by the target device 250 and transmitted back to the source device 200 for later use.

The XY position (e.g., 315b, 320b and 325b on FIG. 3b) describes the location where the object data should be presented on the target device's display 280. For example, if the target device 250 were a television screen, and the television screen were conceptualized as a Cartesian plane in which a location on the screen could be identified by (x, y) coordinates, such that the upper left corner were represented by (0,0) and the bottom right corner were represented by (1920, 1080), the object XY position might specify a coordinate such as (10, 5) indicating that the upper left corner of the object data should be placed 5 pixels down and 10 pixels over from the upper left corner of the screen.

The XY position may further comprise the size of the object (width and height) in pixels. It will be understood, however, that other coordinate and sizing systems may be used to describe where an object should be placed and how large it should be, on a display 280, depending on the nature of the target device 250, its display 280, and the overall constraints of the system. In some embodiments, the width and height of the object may be derived from object data. In most cases, the XY position may be supplied by the source device 200.

The Z-order (e.g., 315c, 320c and 325c on FIG. 3b) may be used to identify where in the “stack” of layers the object should be located. The Z-order value may be a numerical value such that if two objects are overlapping (either partially or completely) on the screen, the object with a greater value will be shown over the object with a smaller value wherever such overlap occurs. For example, as shown on FIG. 1b, the static text and/or graphics 105 is shown as the bottom layer 120. In such a case, the representative object's Z-order might be 0. The second layer 125, representative of the video 110, could have a Z-order of 1. The third layer 130, representative of the menu bar 115, could have a Z-order of 2. In most cases, the Z-order value may be supplied by the source device 200.

It should be understood that the manner and techniques by which Z-order values are assigned to various objects (and the actual values themselves) may be implemented in many different ways and the invention is not limited to any particular implementation. In one embodiment, for example, the operating system 305 may be responsible for assigning and/or changing the Z-order value of all objects.

In another embodiment, for example, the operating system may be responsible for assigning the Z-order value for objects representing the visual elements of the operating system itself (e.g., the object(s) representing the desktop environment) as well as the relative hierarchy of the Z-order values of each application, while each application is responsible for assigning the Z-order value of the objects corresponding to the visual elements of that application. For example, while the operating system may specify that a window associated with application 310a should appear above a window associated with application 310b (i.e., all of the objects representing the visual elements of application 310a should have a higher Z-order value than the objects representing the visual elements of application 310b), each application would have a range of Z-order values (assigned to it by the operating system) that it may assign to its own visual element objects. In such an implementation, Z-order values may have two numerical components—a first component assigned by the operating system which is the same for all objects associated with a particular application, and a second component that is assigned by the application to arrange the hierarchy of its own objects. In this manner, the operating system can easily change the hierarchy of all objects associated with a particular application program by changing the first component.

Regardless, it will be understood that the Z-order can be set up in whatever manner as is desired by the application programmer or designer of the system, provided that the target device 250 can determine with specificity how to overlay each of the layers.

Each object may also contain a variety of object-specific data (e.g., 315d, 320d and 325e on FIG. 3b), i.e., the actual data to be presented, such as images, videos, or even three-dimensional (3D) elements, such as 3D objects or 3D animated objects (not shown). The object data contains information sufficient to redraw the visual element. In addition, in some embodiments, the object data may contain the width and height of the object.

The data preparation subsystem 220 may also be configured to manipulate and update objects. For example, a video stream object, e.g., 325, may contain video stream data 325d which is constantly changing. Thus, the data preparation subsystem 220 may be responsible for updating the object data within this object. In another example, a mouse pointer may be represented as an image object. As a user moves the mouse pointer on a user interface 240, the data preparation subsystem 220 may be responsible for updating the XY position of the correspondent image object, e.g., image object 320, accordingly.

As noted previously, the target device 250 may comprise a data rendering subsystem 270 capable of receiving media content in the form of objects (as described herein) and manipulating those objects in response to updates received from the source device 200. In general, for each object created on the source device 200, a corresponding object may be created on the target device 250 in order to display that object on the target device 250. For example, with respect to objects 315, 320, and 325, corresponding objects shown as 315′, 320′ and 325′ may exist on the target device 250. The corresponding objects 315′, 320′, and 325′ may comprise the same information as objects on the source device 200 (objects 315, 320 and 325), e.g., object ID, XY position, image data and/or video stream data.

It will be appreciated that the corresponding objects on the target device 250 may be created in any appropriate manner. For example, in one embodiment, the source device 200 may transmit a copy of the objects 315, 320, 325 to the target device 250. In another embodiment, the source device 200 may transmit instructions and/or sufficient data such that the target device 250 may create the objects 315′, 320′ and 325′ on the target device 250. It is also to be understood that while objects on the target device 250 (objects 315′, 320′ and 325′) are logically related to objects on the source device 200 (objects 315, 320 and 325) there is no requirement that they be identical. For example, objects on the target device 250 may include extra information specifically tailored to the implementation of the target device 250.

In one embodiment, the data rendering subsystem 270, as shown on FIG. 3a, may comprise a set of visual data processors 350, a Z-order processor 355, a visual object collection manager 360, and a collection of visual objects 365.

In such an embodiment, the visual object collection manager 360 may be responsible for managing a collection of visual objects 365 based on data and instructions received from the source device 200. “Instructions” as used herein includes any form of conveying to the target device 250 actions that should be undertaken by the target device, including with respect to the processing, management or manipulation of visual objects. “Instructions” is broad enough to include, but is not limited to, commands or updates transmitted from the source device 200 to the target device 250. For example, such instructions may include adding a new visual object to the collection 365, updating data within an existing object (for instance, for a video object, the update may contain frame data for a new frame within a video stream), or updating properties of the object (such as its visual data, Z-order value, XY position, or its visibility). The visual object collection manager 360 may process and execute such instructions.

The one or more visual data processors 350 may be used to manipulate various types of object data. For example, for image and video objects, visual data processors 350a and 350b may be able to decompress pictures and video streams compressed by different methods (for instance, JPEG or PNG for pictures, and H.264 AVC or VC-1 for video streams). Other visual data processors 350c may be capable of processing 3D object data, for example, by containing one or more 3D engines to render 3D elements. Depending on the embodiment, there may be multiple image decompressors 350a, multiple video stream decompressors 350b, multiple 3D engines 350c, or multiple other types of visual data processors (not shown) within the same data rendering subsystem 370.

The Z-order processor 355 may be used to combine all or a subset of visual objects contained in the collection 365 on the display 280 of the target device 250 according to their Z-order and XY position (for example, as it was illustrated on FIG. 1). Optionally, the Z-order processor 355 may perform “double buffering,” a technique known in the art of computer graphics which is used for drawing graphics that shows no (or reduced) flicker, tearing, and other artifacts.

As noted, FIG. 3a depicts a logical representation of one embodiment of the data rendering subsystem 270. Thus, although the term “processor” is used with respect to the visual data processors 350 and the Z-order processor 355, these terms should be understood as logical descriptions and not as descriptions of specific electronic components (such as a microprocessor). It is to be understood that all of the logical elements of the data rendering subsystem 270, including the visual data processors 350 and the Z-order processor 355 of the embodiment pictured in FIG. 3a, may be implemented in hardware, software, or any combination thereof, as may be dictated by the specific nature of the target device 250, the type of applications to be performed by the target device 250, and any other constraints of the overall system. The invention is not limited to the particular embodiment shown on FIG. 3a, and other implementations of the data rendering subsystem 270 are also within the scope of the present disclosure.

To facilitate the transmission of media content from the source device 200 to the target device 250, the data preparation subsystem 220 and the data rendering subsystem 270 may work together to provide different processing and manipulation for different object types.

Of the three exemplary object types discussed herein, images, videos, and 3D elements, image objects are likely to be the simplest. An image object, e.g. 315, may be formed within the data preparation subsystem 220, and may contain a bitmap of the image, an XY position for display on the target screen, and a Z-order. A corresponding image object 315′ may be stored in the visual object collection 365 within the data rendering subsystem 270. Image data can be updated or deleted as necessary within object 315, and the data preparation subsystem 220 may send the appropriate instructions and image data via the communication link 290 to update the object 315′. As described in more detail above, image bitmaps may be partially transparent by, for example, using an alpha-channel.

Video objects, shown as 325 on FIG. 3b, may be more complicated. In addition to the XY position and Z-order, video objects may have meta data 325d (which may include, for example, video frame rate), and may need the video stream data 325e to be constantly refreshed. For example, in one embodiment, an application 310 may be responsible for supplying video stream data (which may be any type of frame, including I-frame, P-frame or B-frame) to the object 325. These updates may be transmitted to the corresponding video object 325′ on the target device 250 via the communications link 290.

In such an embodiment, it may be desirable for the application 310 to send frame data of a video stream some predetermined amount of time earlier than it should be displayed on the target device 250, i.e., the application 310 may delay sending data about other objects as compared to the video stream data. The received frame data may be buffered in a memory (not shown) within the data rendering subsystem 270 (for example, within video stream decompressor 350b), and may be used by the target device 250 according to the meta data of the video object 325′. For example, if, according to the meta data, the video data has a constant frame rate, the target device 250 may choose not to display frames on the display 280 as soon as they have arrived via the communication link 290 but rather according to an internal timer in accordance with the frame rate specified by the meta data. This buffering may allow the target device 250 to compensate for possible delays and/or short bursts within the communications link 290.

In some embodiments, in order for the source device 200 to know when and how much frame data to send at any given point in time, the source device 200 may know the amount of memory that is available on the target device 250 for buffering video frame data. This information may be made known to the source device 200 in any appropriate manner. In one example, the target device 250 may communicate this information to the source device 200 at any appropriate time after a communication link is established between them. In another example, the source device 200 may have a look-up table or similar data structure that includes this information for some or all target devices 250 (e.g., for certain model numbers of TVs).

Additionally, the source device 200 may need to know the correspondence between particular frames and the amount of time that has elapsed in the video stream. For purposes of illustration only, the source device 200 may need to know, for any given frame, how much time has elapsed in the video stream. Or conversely, the source device 200 may need to know, given a certain amount of time having elapsed in the video stream, what frame corresponds to that moment in time in the video stream. Having this information, the source device 200 can make better determinations as to when and how much frame data to transmit to the target device 250 to ensure that neither too much nor too little frame data is provided to the target device 250 at any point in time. In many practical cases, such frame/time correspondence information is available from information that accompanies the video stream. For example, the MPEG-4 and ASF container formats include such frame/time correspondence information. If this information is not readily available, in some embodiments, the system may use a form of flow control to accomplish the same end, whereby the target device 250 informs the source device 200 about the amount of the buffer that is in use and whether the buffer can accommodate additional frame data.

It should also be noted that if the video is compressed and the video compression algorithm uses so-called I-slices, P-slices and/or B-slices (instead of or in addition to I-frames, P-frames and B-frames), they may be handled in the same manner as frames.

The data preparation subsystem 220 and the data rendering subsystem 270 may also work together to efficiently distribute the compression and decompression of video data between the source device 200 and the target device 250 based on the characteristics of each device and the type of data to be transferred.

For example, in one embodiment, the data rendering subsystem 270 on the target device 250 may comprise one or more relatively simple decoders capable of decompressing certain types of compressed video streams, such as (but not limited to) H.264 AVC, MPEG-2 part 2, VC-1, or WMV9, but which is not capable of opening and processing “container formats” such as ASF, AVI, or Matroska (which typically contain video stream information, plus other information such as meta data, menus, and subtitles). Without any additional processing capability in the source device 200, it would not be possible to view a video stored in an unsupported container format on the target device 250.

In such a case, the data processing subsystem 220 may be configured to open the container and extract the video stream. Depending on the container format and the characteristics of the target device 250, the video stream in the container may already be (1) compressed using an algorithm recognizable by the data rendering subsystem 270, (2) compressed using an algorithm which is not supported by the data rendering subsystem 270, or possibly (3) not compressed.

The source device 200 may acquire information regarding the decompression capabilities of the target device 250 in different ways, according to the specific embodiment. For example, in certain embodiments the target device 250 may support a specific set of decompression algorithms, i.e., the target device 250 may recognize and be capable of decoding certain compression algorithms. In one such embodiment, the source device 200 may be preprogrammed to associate particular algorithms with particular target devices 250. For example, it may be predefined within the source device 200 that a particular target device 250, such as a particular brand of television, recognizes a set of algorithms. In another exemplary embodiment, the target device 250 may use the communications link 290 to report its decompression capabilities to the source device 200 before any media content is transmitted.

If the video stream data in the container is compressed using an algorithm supported by the data rendering subsystem 270 of the target device 250, the data preparation subsystem 220 may not need to perform any additional preprocessing. In such a case, once the data has been extracted from the container it can be transmitted directly to the target device 250 which can decompress the data for presentation to the user. This is an optimal scenario, as it requires less bandwidth than the transmission of uncompressed data, but leaves resource-intensive processing to the target device 250, which is likely to have more powerful resources or specialized hardware (e.g., ASICs) or software to decompress and render the data.

If the video stream data in the container is compressed, but has been compressed using an algorithm not supported by the data rendering subsystem 270 of the target device 250, the data preparation subsystem 220 may extract the data and convert it into a format which is supported by the target device 250. In one embodiment, the data preparation subsystem 220 may first decompress the video data. Second, the data preparation subsystem 220 may recompress the data using a compression algorithm recognized by the data rendering subsystem 270. For example, the data preparation subsystem 220 may recompress the data using a fast compression algorithm such as Motion JPEG. It is to be understood that other compression algorithms may be used and the specific form of compression may depend on the nature of the data to be compressed. In one embodiment, this compression may be performed by the operating system 305, without affecting any applications 310. In another, an application 310 itself may perform this compression. In yet another embodiment, this compression may be performed by dedicated hardware (not shown) within the source device 200, such as an application-specific integrated circuit.

By having the source device 200 extract the video stream data from the container and transmitting the compressed video stream to the target device, the data rendering system 270 may be relatively simple in that it need only have the hardware and associated software to decompress several known compression algorithms, instead of needing hardware and software necessary to open and process dozens of changing container formats, which could require frequent software and/or hardware updates on the target device 250.

Similarly, by having the source device 200 process and transmit the web page as one or more visual elements, the target device 250 need not include hardware and software for processing and implementing frequently changed standards such as HyperText Markup Language and/or Cascading Style Sheets (which are common technologies for specifying web pages).

It will be understood, however, that in a different embodiment the target device 250 may be something more complex, such as a computer, and may actually support multiple container formats as well as compression algorithms. In such a case, the source device 200 could actually send the entire container to the target device 250.

If the video stream data in the container is uncompressed, the target device 250 may be capable of presenting the data on its display 280 in accordance with the methods already described without performing any significant additional processing. However, the transmission of uncompressed video data can require significant bandwidth, and the overall system may not include an adequate amount of bandwidth. In such a case, the data processing subsystem 220 may be configured to perform some kind of fast video compression on the video stream data before transmitting the data to the target device, using a compression algorithm the target device 250 is capable of decoding. For example, “Motion JPEG” compression may work well, although it is to be understood that other compression algorithms may be used and the specific form of compression may depend on the nature of the data to be compressed.

Certain embodiments of the present disclosure also support the transmission of three-dimensional (3D) objects (not shown). These objects are characterized (in addition to their XY position and Z-order) by 3D scenes which may be rendered on the target device 250.

In one embodiment, the data preparation subsystem 220 on the source device 200 may comprise a 3D engine capable of understanding 3D commands such as, for example, a subset of OpenGL language or DirectX, while the data rendering subsystem 270 on the target device 250 does not. In this embodiment, rendering of the 3D data may occur within the source device 200. Once the 3D data has been rendered by the data preparation subsystem 220, the data may be compressed using a fast video compression algorithm that can be decompressed by the target device 250.

In an alternative embodiment, as shown in FIG. 3a, the data rendering subsystem 270 of the target device 250 does include a 3D engine 350c capable of understanding and implementing 3D commands. In this embodiment, whenever an application 310 issues a 3D function call, the call can be marshaled by the application 310 and/or the operating system 305 and transmitted over the communication link 290 to the data rendering subsystem 270, where the call may be unmarshaled and relayed to the 3D engine 350c. Relaying 3D function calls over the communications link 290 in this manner, instead of rendering them on the source device 200 and sending rendered pixels to the target device 250, may reduce the required communication bandwidth as well as the power consumption of the source device 200.

Many of the types of media content described herein (e.g., movies or video clips) may also include an audio component. For example, an MPEG4 container may also include an audio stream. As another example, a game application may dynamically generate an audio output during game play depending on actual game events. It will be understood that the source device 200 may also include software and/or hardware to process the audio information and transmit the audio information to the target device 250, and that the target device 250 may also include software and/or hardware to process the received audio information and present the information to the user (e.g., through speakers, not shown) along with the media content.

The foregoing descriptions have described transmission of instructions, data and/or updates from the source device 200 to the target device 250 using the communications link 290. It will be understood, however, that this link may be configured in a variety of ways. For example, in one embodiment, it may be desirable to create a logical channel for each object, shown as channels 370, 375 and 380 on FIG. 3b. In this manner, data and instructions may be transferred in a logically independent manner for different objects, but are physically transferred over the same physical connection link 290; such an implementation of multiple logical channels over a single physical channel may be achieved, for example, via serialization of data transfer. In one embodiment, such serialized data transfer may be implemented by sending all communications over a single TCP connection. In an alternative embodiment, independent TCP connections may be established for different objects; in this case it will be the TCP stack (for example, the TCP stack of the operating system), which will effectively perform serialization.

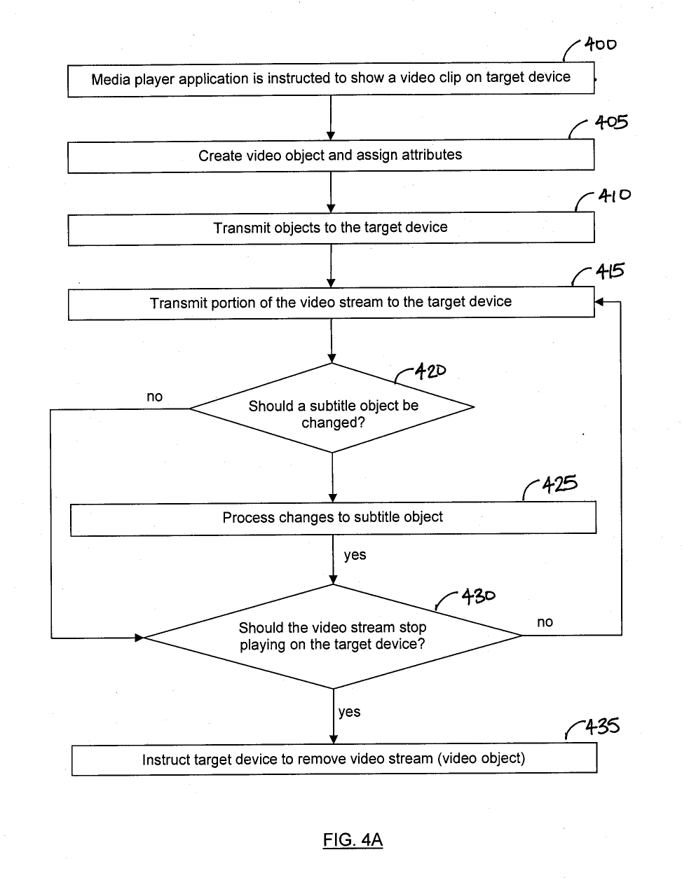

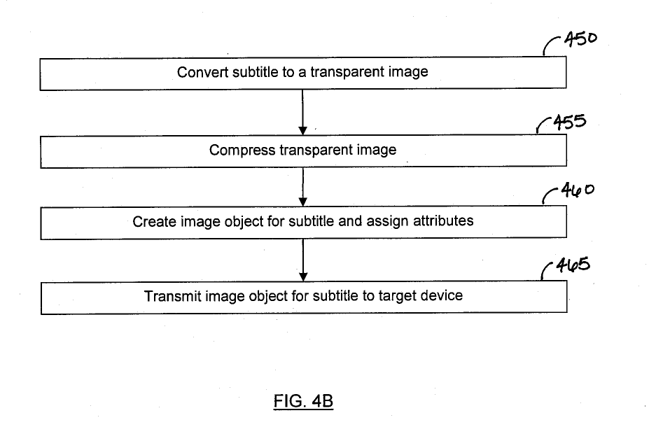

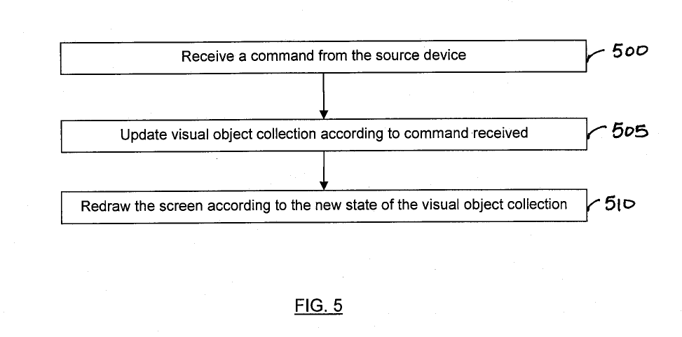

FIGS. 4a-8c show how different applications may transmit data from a source device 200 to a target device 250 according to various methods of the present disclosure. It will be understood that other applications, not described herein or not yet developed, can utilize similar methods by analogy.

FIG. 4a is a flow diagram illustrating an exemplary embodiment in which a media player application 310 running on the source device 200 prepares and transmits a video clip with subtitles for display on a target device 250.

As shown on FIG. 4a, at step 400, the user may instruct a media player application 310 running on the source device 200 to show a video clip on the target device 250. As a result, at step 405, the media player application 310 may create a video object and assign the necessary attributes of this video object—a unique object ID, the XY position, a Z-order value, and a video stream of the clip. At step 410, the source device 200 may transmit the video object to the target device 250. Depending on the embodiment, the entire video stream may not be transmitted with the video object at this step 410; but rather, only a portion of the video stream may be transmitted with the object, such as a single frame, or a group of frames comprising a subset of the whole video stream. The object can be updated with additional frames in a later step, such as step 415.

At step 415 the source device 200 may transmit a portion of the video stream data (e.g., one or more compressed frames of the video stream, but not necessarily the entire video stream) associated with the video object to the target device 250 via the communications link 290 and the target device 250 may begin displaying this data on the display 280. In one embodiment, the target device 250 may begin decompressing and displaying video data as soon as it has received the first renderable frame of the stream (usually this is the first I-frame in a compressed stream). Meanwhile, the application 310 may send instructions to the target device 250 to update or modify the associated video stream object, supplying more frame data (which can be any kind of frames, including I-frames, P-frames or B-frames). In one such embodiment, this updated video frame data can be buffered in a memory (not shown) within the data rendering subsystem 270 and rendered according to stream meta data (such as for example, the video frame rate).

Thus, in such a system, and as described in more detail previously, the target device 250 does not need to understand various container formats which might be used for storing video clip data (such as the commonly used MP4 container format, ASF (Advanced Streaming Format) or Matroska Multimedia Container), but only needs to be able to decompress a selected number of different types of compressed video streams. It is not required that the media player application 310 running on the source device 200, or the source device 200 itself, have the capability to decode compressed video streams, which, in many cases, is computationally intensive. Instead, the media player application 310 may open the video clip file container and extract the compressed video stream, and then incorporate this compressed video stream into a video object for transmission to the target device 250. This, as noted previously, is a distribution of labor which reduces transmission bandwidth requirements and the processing resources used by the source device 200.

There may be additional objects associated with the video clip. For example, there might be subtitles associated with particular frames or sequences of the video. These subtitles can be converted to images and manipulated as image objects. In such a case, at step 420, the media player application 310 may determine whether some manipulation of a subtitle image object should occur based on, for example, the current video frame. Then the media player application 310 may perform all such manipulations. For simplicity, FIG. 4a shows all such possible operations as step 425, “process changes to subtitle object”; however, this step 425 is discussed in more detail with respect to FIG. 4b below. To ensure that the instructions with respect to all objects are synchronized properly (e.g., when to start playing a video stream, when to start displaying a first subtitle, when to stop displaying a first subtitle, etc.), in some embodiments of the methods described herein with respect to FIGS. 4a-8c, it may be desirable to store all instructions relating to all objects in the same buffer (not shown) so that the instructions are executed sequentially and in the proper order.

If, at step 430, it is determined that the video stream has not ended, steps 415 through 425 may be repeated as necessary with subsequent frames of the video stream.

Alternatively, at step 430 the video clip may be complete (or a user may instruct the media player application 310 to stop showing the clip). In that case, at step 435, the target device 250 may be instructed to remove the video object (and other objects, if any, such as any subtitle image object) from the visual object collection 365 and to update the screen 280, thus stopping the video clip. For example, the target device 250 may receive a command from the source device 200 to remove all objects from the collection 365. In another embodiment, the target device 250 may automatically perform this action upon completion of the video clip.

FIG. 4b expands step 425 to describe in detail one method by which a new subtitle may be displayed over the existing video stream. It should be understood that this exemplary method is provided for the purpose of illustration and is not intended to narrow the scope of the invention as claimed.

For some video streams, subtitles are stored in a text form. For example, in the MP4 container format, subtitles may be a separate text stream. In other situations, subtitles may be contained in a separate .srt type file. Thus, at step 450, as shown on FIG. 4b, the media player application 310 may first convert the text of the subtitle to a partially transparent bitmap (as described in more detail previously), and then, at optional step 455, the media player application 310 may compress the bitmap using a compression method such as PNG. In such an embodiment, the target device 250 does not need the capability to understand and/or render font information (as would be required to display text-based subtitles). Rather, the source device 200 would be responsible for converting the text-based subtitles to a (optionally compressed) bitmap.

At step 460, the media player application 310 may create an image object and assign the necessary attributes—the object ID, XY position, Z-order value, and the bitmap (or compressed PNG) data. As the subtitle text should appear on top of the video, the media player application 310 should assign a greater Z-order value than that of the video stream. At step 465 the media player application 310 may transmit the image object to the target device 250. When the target device 250 receives the image object, it may begin displaying the received bitmap on its screen 280 over the video as intended.

After a certain period of time it may be that an existing subtitle, displayed, for example, in accordance with the steps shown on FIG. 4b, should be removed from the screen 280, such as because the video sequence has advanced and the subtitle is no longer relevant. Then, at step 425, the method may consist of a single step in which the media player application 310 may send to the target device 250 an instruction to remove the image from the screen 280, specifying the image's object ID. The data rendering subsystem 270 may update the screen 280 so as to reflect the removal of the subtitle.

FIG. 5 shows a method for receiving and processing data for presentation on the display 280 generally. As shown, at step 500 the target device 250 may receive an instruction from the source device 200. Such an instruction could be, for example, to add an image to the visual object collection 365, to add a new video object to the collection 365, to remove an image from the display 280, to remove a video stream from the display 280, to update the video data within an existing video object, or the like. Each such instruction may contain an object ID (e.g., 315a, 320a and 325a on FIG. 3b), and some data, if applicable (for instance, an instruction to add an image may be accompanied with image data). For example, if at step 425 on FIG. 4a a new subtitle should be shown, and, correspondingly, at step 465 on FIG. 4b an image object is transmitted by the source device 200, then at step 500 the target device 250 may receive an instruction to add an image object, together with image data, to the visual object collection 365.

As a result, at step 505, the visual object collection manager 360 may update the visual object collection 365 according to the instruction received from the source device 200. For example, the visual object collection manager 360 may store a new object in the visual object collection 365. In one embodiment, the source device 200 may transmit an object which can be stored directly within the visual object collection 365. In another embodiment, the source device 200 may simply transmit an instruction to the visual object collection manager 360, directing the manager 360 to create a new visual object within the visual object collection 365. It will be understood, however, that these are two of many possible ways of creating a new object on the target device 250, and any suitable method may be used.

Then, to actually reflect the changes made to any visual object, at step 510, the target device 250 may refresh its display 280 according to the new state of the visual object collection 365. Steps 500-510 may be repeated as long as two devices maintain a communication link with each other.

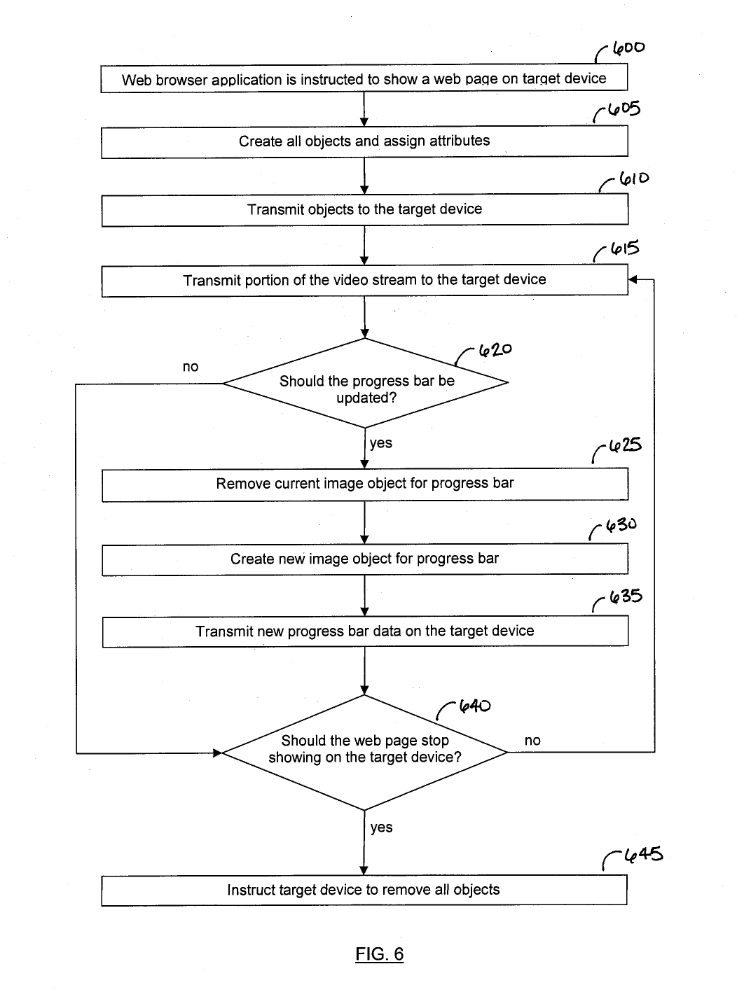

FIG. 6 shows yet another implementation of a system according to the present Disclosure—here a web browser application 310 displaying a web page on the display 280 of a target device 250, such as, for example, on a television screen.

At step 600, a user may instruct a browser application 310 running on the source device 200 to show a web page that includes a video component (such as the exemplary web page shown on FIG. 1a) on the screen of the target device 250. At step 605, the web browser application may create visual objects corresponding to the elements of the web page as shown and discussed with respect to FIG. 1b, and may assign each object's attributes, such as the object ID, XY position, Z-order value, and underlying data (e.g. video or image data) for each object. In this example, the Z-order value of the image object representing the menu and/or progress bar 115 may be the highest, for instance, 3, as it is over the video stream 110; the video may have an intermediate Z-order, such as 2. The Z-order of the remaining image with background and text 105 may be the lowest, for instance, 1. The web browser application may also convert the text and/or graphics 105, or other objects, like menu 115, into images, and extract the video stream data from the container. For example, the video on the web page may be incorporated into the web page using technology commonly referred to as Flash. In that case, the web browser application may process the Flash container to extract the encoded video stream (which may, for example, be H.264 AVC video stream) included within that container. It is to be understood, that the present disclosure is not limited to Flash video and any type of video embedding technology and media content container format may be used.

At step 610, the web browser application 310 may transmit the objects with their attributes to the target device 250, and at step 615 the web browser application 310 may transmit one or more frames of the video stream. As soon as the initial state of each of these objects is received (for example, the first renderable frame of the video stream, as described in further detail with respect to FIG. 4), the target device 250 may begin showing each object on the display 280 according to their respective XY positions and Z-order values, as well as any applicable meta data.

While the video is being displayed on the target device 250, the state of the progress bar 115 may be changing. If, at step 620, the state has been changed, then to reflect such changes on the display 280 of the target device 250, at step 625, the web browser application 310 may update the corresponding image object on the target device 250. To do so, the web browser application 310 may send a “remove” instruction to the visual object collection manager 360 containing the object ID of the image representing the current state of the progress bar 115 (as set at step 620). At step 630, the web browser application 310 may prepare an image corresponding to the new state of the progress bar 115, and assign the necessary attributes. At step 635, the application 310 may transmit this object to the target device 250 to be displayed. At step 640, if the video clip is not complete, steps 615-635 can be repeated as necessary.

If on the other hand, at step 640, the video clip is complete or the user instructs the web browser application 310 to stop showing the web page on the target device 250, at step 640, the web browser application 310 may send one or more instructions to the target device 250 containing the object IDs of all visual objects associated with the web page and to remove them from the screen.

It will be appreciated that in such an embodiment, the target device 250 need not know, for example, how to render a web page, how to work with container formats, such as the Flash container format, or how to properly display and update the progress bar 115. Also, as noted with respect to FIG. 4, the web browser application 310 need not perform any video stream decoding or encoding, but rather may be able to simply extract the video stream from a container, if necessary, and transmit the encoded video stream to the target device 250.

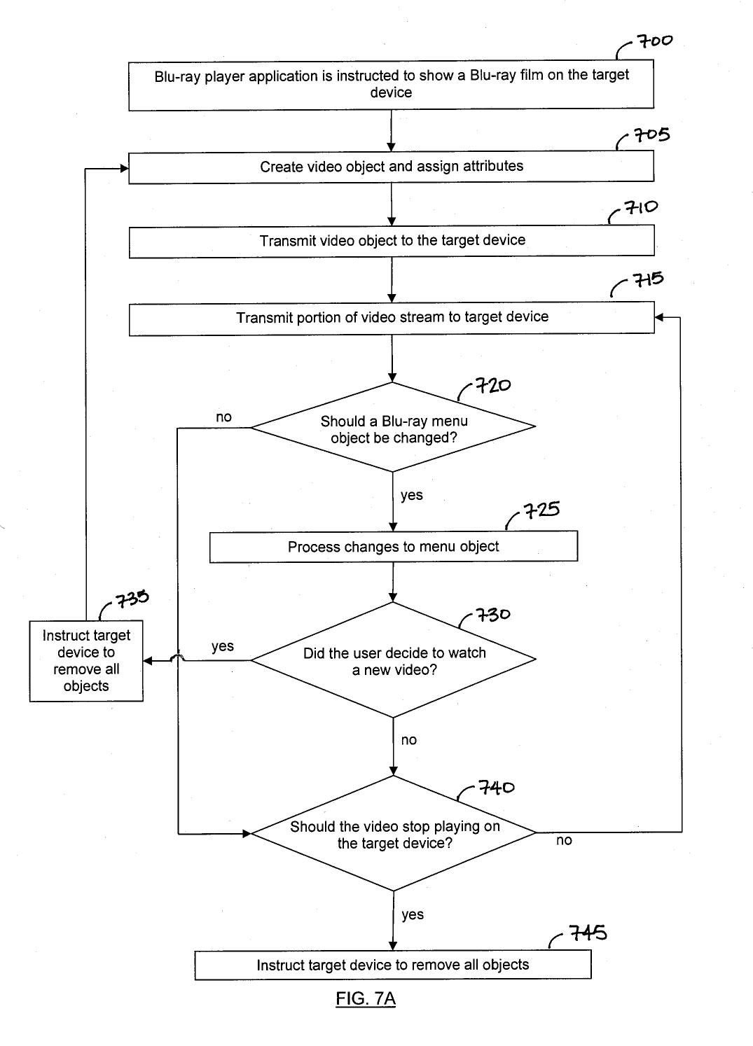

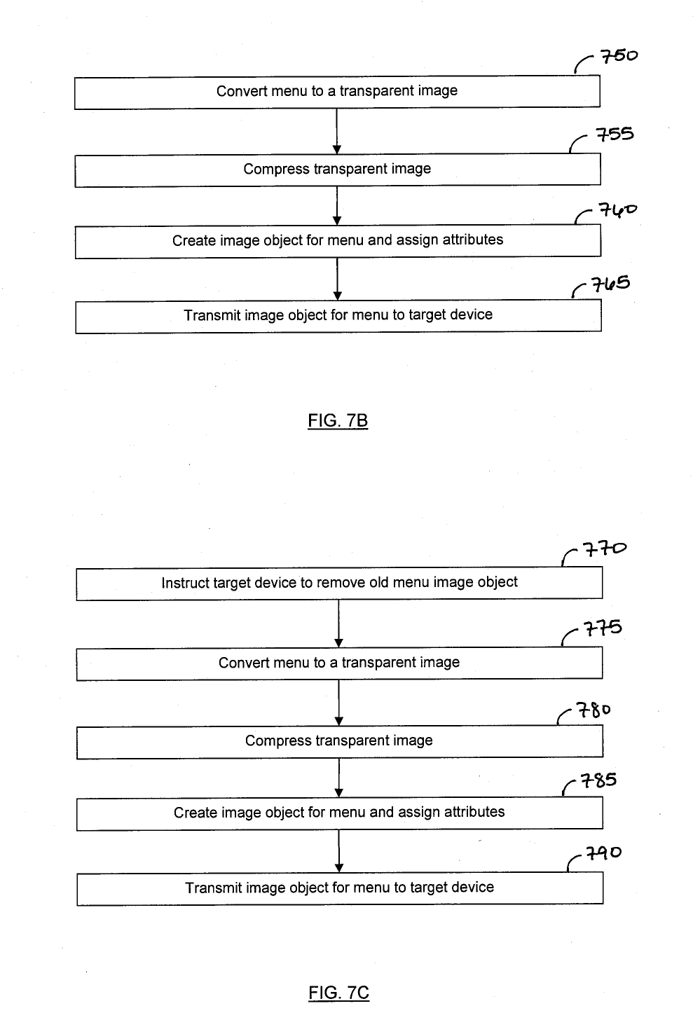

FIGS. 7a is a flow diagram illustrating an embodiment in which a Blu-ray player application 310 running on the source device 200 may display Blu-ray content on the screen 280 of the target device 250. The Blu-ray content could be, for example, from a physical disc inserted into a source device 200 such as a laptop, or a Blu-ray ISO image downloaded from the Internet (potentially with DRM protection).

As shown on FIG. 7a, at step 700, the user may instruct the Blu-ray player application to start showing a movie on the target device 250.

In most cases, when a Blu-ray disc starts playing, a default video stream is shown to the user. If this is the case, at step 705, the Blu-ray player application 310 may create a video object incorporating this default video stream and assign the necessary attributes to this object. In such a case, the Z-order of this video object may be set to a low value, for instance, to 1, as any other potential content, such as menus, will likely be shown over it. At step 710, the application 310 may transmit the video object to the target device 250, and at step 715, the application 310 may transmit one or more frames of a video stream to the target device 250.

Much like the foregoing examples with respect to video clips, Blu-ray movie discs comprise compressed video streams which are typically recognizable by common target devices 250, such as televisions. Therefore, to show the video content of a Blu-ray movie on the screen of the target device 250, the Blu-ray player application 310 does not need (nor does the source device 200 itself need) the capability to decode or encode video streams. Similarly, the target device 250 need not understand the internal details of the Blu-ray disc format or possess any interactive logic, but should be able to decompress and display encoded video streams.

In many cases, Blu-ray discs are capable of displaying a menu over the default video stream. In both the BD-J and BD-MV formats, menus are not a part of a video stream, but are formed dynamically in response to a user's interaction with the player. For instance, the Java programming language is used to implement interactive menus when the Blu-ray disc uses BD-J format, and the content of such menus is formed by a Java Virtual Machine (JVM) embedded in the player. (In the BD-MV format, the logic of forming menus is different, though the end result is roughly the same).

At step 720, the Blu-ray player application 310 may be about to perform some type of action associated with a menu, such as, for example, display of a new menu, update or removal of an existing menu, etc. To simplify the present discussion, all options and processing related to such a menu have been shown on FIG. 7a as step 725, “process changes to menu object.” However, a more detailed description of exemplary methods for handling different menu operations is provided below with respect to FIGS. 7b and 7c. Steps 715 through 725 may be repeated as necessary.

At step 730, the user may have made a selection on the menu such as to play trailers, or any other alternative stream contained in the Blu-ray movie. In such a case, the player 310, at step 735, may send to the target device 250 an instruction to remove the current video stream object. As a result, the target device 250 may stop showing the current (default) video stream, and may return to the step of creating a new video object, step 705. The Z-order value of the new stream should be set to a low value, for instance to 1, as other potential visual content, such as menus, may still be shown above it. The method may then send the object to the target device 250 at step 710 and begin transmitting the new video stream to the target device 250 at step 715.

Finally, at step 740, the user may instruct the player to stop playing the movie on the screen of the target device 250 (or the video itself may complete). Thus, at step 745, the Blu-ray player application may send one or more instructions to the target device 250 to remove all visual objects related to the movie, such as the current video stream, menu, etc., using the object IDs assigned when the objects were transmitted to the target device 250.

FIGS. 7b and 7c illustrate various exemplary steps which may be performed to implement certain types of menu operations at step 725. It should be understood that these examples are for purposes of illustration and are not intended to narrow the scope of the invention as claimed.

FIG. 7b shows one method for displaying a new menu over an existing video stream. At step 750, the Blu-ray player application 310 may first convert the menu to a partially transparent bitmap (as described in more detail previously), and then, at optional step 755, the Blu-ray player application 310 may compress the bitmap using a compression method such as PNG. Then, at step 760, the Blu-ray player application 310 may create a new image object representative of the menu and load into the image object the necessary attributes—the object ID, XY position, Z-order value, and the bitmap (or compressed PNG) data. As the menu is intended to be displayed over the video, the Z-order value of the image may be set higher than that of the Blu-ray stream, for instance, to 2. At step 765, the source device 250 may transmit the image object to the target device 250 and the method may return, for example, to step 730.

In this example, the target device 250 need not have the capability of performing any menu selection scenario; menu selections can still be made through the user interface 240 of the source device 200, or through the operating system 305 or an application 310 running on the source device 200. Therefore, the target device 250 does not need to have a JVM or the like because the JVM may run on the source device 200.

FIG. 7c shows an exemplary method by which an existing menu may be updated. An update can be conceptualized in one implementation as first, the removal of the old content, and then second, as the addition of new content. Thus, at step 770, the player 310 may send to the visual object collection manager 360 of the target device 250 an instruction to remove the old menu images with their correspondent object IDs. Then, at step 775, the Blu-ray player application 310 may convert the new menu to a partially transparent bitmap, and, at optional step 780, the Blu-ray player application 310 may compress the bitmap. At step 785, the Blu-ray player application 310 may create a new image object representative of the new menu and load into the image object the necessary attributes. At step 790, the source device 250 may transmit the new image object to the target device 250 and the method may return again, for example, to step 730.

Finally, to remove a menu, step 725 may be implemented as a single step in which the source device 200 issues to the target device 250 an instruction to remove all menu images with their correspondent object IDs

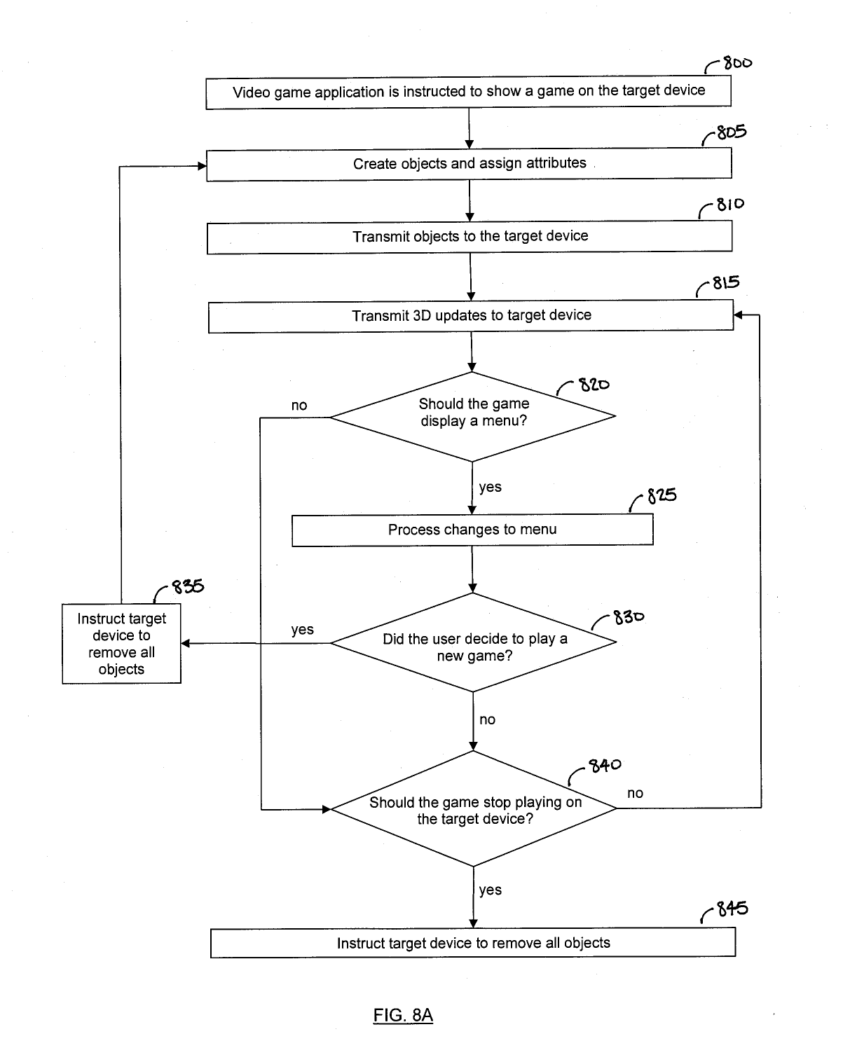

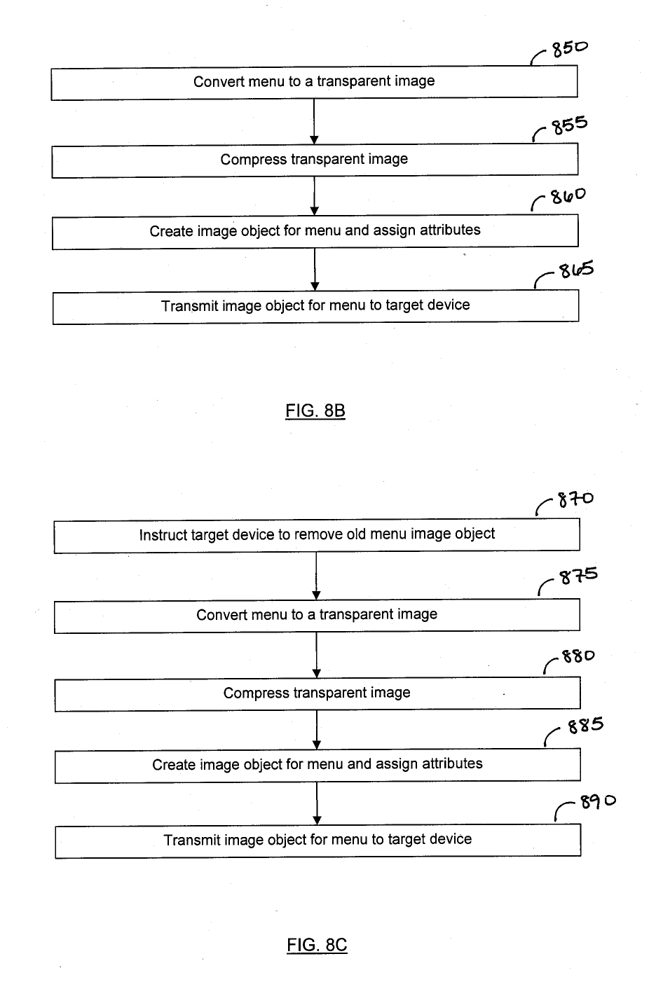

FIG. 8a is a flow diagram illustrating an embodiment in which a video game application shows a game on the screen of a target device 250 such as a computer or a television. Such a game may be run by the operating system 305, for example, in a standard operating system window (while other operating system applications are running on the same screen). This game window may include 3D animation representing visual content of the game and, occasionally, pop-up objects, like menus, for receiving certain kinds of user input in process of game playing.

As shown on FIG. 8a, at step 800, the video game application may be instructed to start showing a game on the display 280 of the target device. At step 805, the video game application 310 may create the objects necessary to represent the visual elements of the game, such as 3D animation objects (or other 3D elements), and may assign each object's attributes, such as the object ID, XY position, Z-order value, and underlying data for each object. For the purposes of this example, the data preparation subsystem 270 of the target device 250 has a 3D engine capable of understanding and implementing 3D commands. In one implementation, the video game application may receive a range of Z-order values (e.g., from the operating system) that it can assign to the objects comprising the visual elements of the game in order to manage the hierarchy of their appearance on the screen. As discussed previously, another implementation is possible in which the Z-order value has two components--a first component that may be used by the operating system to assign the hierarchy of the game application among other applications appearing on the display, and a second component that may be used by the video game application to manage the hierarchy of its objects.

At step 810, objects representative of the video game may be transmitted to the target device 250, and at step 815, the 3D animation object may be updated with 3D data. Similar to the processing associated with video streams, once the initial state of the 3D scene has been specified, the application 310 may send an instruction to the visual object collection manager 360 instructing it to modify the 3D scene, which will result in showing a typical video game with a dynamic 3D picture on the display 280 of the target device 250.

At step 820, the video game application 310 may transition to a state in which a menu is appropriate, allowing the user to make some kind of selection (for instance, to save/load the game state). Again, to simplify the present discussion, all options and processing related to such a menu are shown on FIG. 8a as step 825, “process changes to menu.” A more detailed description of exemplary methods for handling different menu operations is provided below and with respect to FIGS. 8b and 8c.

At step 830, the user may have selected an item on the menu and clicked on it. Depending on the user's selection, certain actions may be performed which no longer necessitate the menu. For example, the user may select “play new game”. Thus, at step 835, the video game application 310 may send a command to the target device 250 to remove all objects associated with the current game. Steps 805 through 830 can be repeated as necessary with respect to the new game.

At step 840, the user may instruct the video game application 310 to stop showing the game on the target device display 280 and, at step 845, the video game application 310 may send a command to the target device 250 instructing it to remove all visual objects associated with the game.

FIGS. 8b and 8c illustrate various exemplary steps which may be performed to implement certain types of menu operations at step 825. It should be understood that these examples are for the purpose of illustration and are not intended to narrow the scope of the invention as claimed.

FIG. 8b shows one method for displaying a new menu over an existing game. At step 850, the video game application 310 may convert the menu to a partially transparent bitmap and at optional step 855, the video game application 310 may compress the bitmap using a compression method such as PNG. Then, at step 860, the video game application 310 may create a new image object representative of the menu and load into the image object the necessary attributes. As the menu should be displayed over the game video, its Z-order should be set to a value higher than the objects representative of the video game graphics. At step 865 the video game application may transmit the menu image object to the target device 250 for display by the target device 250.

FIG. 8c shows one method by which an existing menu can be updated. At step 870, the video game application 310 may send to the visual object collection manager 360 of the target device 250 an instruction to remove the old menu images with their correspondent object IDs. Then, at step 875 the game 310 may convert the new menu to a partially transparent bitmap, and, at optional step 880, the game 310 may compress the bitmap. At step 885, the video game application 310 may create a new image object representative of the new menu and load into the image object the necessary attributes. At step 890, the source device 250 may transmit the new image object to the target device 250 and the method may return again, for example, to step 830.

Finally, to remove a menu, step 825 may be implemented as a single step in which the source device 200 issues to the target device 250 an instruction to remove all menu images with their correspondent object IDs

The foregoing examples provided with respect to FIGS. 4a-8c have all described applications specifically tailored to implement the methods disclosed herein, such as the video game application 310 described with respect to FIGS. 8a-c. However, it will be understood that applications need not be specifically programmed to implement the methods described herein. For example, the methods described herein could be implemented as a standalone application, a plug-in or a driver. A presently existing video game application, or a new Blu-ray application designed by programmers having no knowledge of the present disclosure, could nonetheless make use of the presently-disclosed methods by, for example, running on an operating system having a special driver implementing these methods. The present invention is intended to cover all of these variants with respect to the implementation of the methods disclosed herein and any applications making use of such methods to transmit media content.

In addition, it will be understood that the foregoing examples shown in FIGS. 4a-8c are but a few of the possible types of applications which could make use of the disclosed invention. For instance, an application using sprites (two-dimensional images that are integrated into a larger scene) as part of its visual content could render each sprite as a separate object, and, correspondingly, transmit each object separately to the target device. Similarly, mouse cursor movements could be rendered as images on the target device 250, such that the XY position of the correspondent image is updated each time the mouse cursor is moved on the source device 200.

While specific embodiments and applications of the present invention have been illustrated and described, it is to be understood that the invention is not limited to the precise configuration and components disclosed herein. The terms, descriptions and figures used herein are set forth by way of illustration only and are not meant as limitations. Various modifications, changes, and variations which will be apparent to those skilled in the art may be made in the arrangement, operation, and details of the apparatuses, methods and systems of the present invention disclosed herein without departing from the spirit and scope of the invention. By way of non-limiting example, those with ordinary skill in the art recognize that certain steps and functionalities described herein may be omitted without detracting from the scope or performance of the embodiments described herein.

The various illustrative logical blocks, modules, circuits, and algorithm steps described in connection with the embodiments disclosed herein may be implemented as electronic hardware, computer software, or combinations of both. To illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the present invention.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art.

The methods disclosed herein comprise one or more steps or actions for achieving the described methods. The method steps and/or actions may be interchanged with one another without departing from the scope of the present invention. In other words, unless a specific order of steps or actions is required for proper operation of the embodiment, the order and/or use of specific steps and/or actions may be modified, including not performing particular step or steps, without departing from the scope of the present invention.

What is claimed is:

1. A system for transmitting and displaying at least one media content comprising:
a source device comprising: a data preparation subsystem configured to represent media content as one or more elements, create one or more visual objects, assign an object ID, an object data, an XY position and a Z-order designation to each object, and manage and update the one or more visual objects, wherein each element embodies a separate layer of the media content, wherein each visual object corresponds to one of the one or more elements, and wherein each visual object can be managed and updated independently; and a first communications port coupled to the data preparation subsystem to transmit the one or more visual objects to a target device and to transmit one or more instructions to a target device to update the one or more visual objects; and
the target device comprising: a second communications port to receive the one or more visual objects and to receive one or more instructions to update the one or more visual objects; a data rendering subsystem to independently manage and update each visual object, to process the object data of each visual object, and to combine the one or more visual objects according to their Z-order designations to recreate the media content for presentation to a user; and a display to present the recreated media content to a user.

2. The system of claim 1, wherein the data preparation subsystem further comprises an operating system and one or more application programs configured to run on the operating system.

3. The system of claim 2, wherein the one or more visual objects is comprised of at least one video object and at least one image object, and wherein the Z-order designations of the image object and the video object are such that the image object is displayed on top of the video object.

4. The system of claim 3, wherein the at least one image object is a partially transparent image object.

5. The system of claim 4, wherein the first and second communications ports are based on a wireless protocol, such that visual objects and instructions may be transmitted from the source device to the target device wirelessly.

6. The system of claim 5, wherein the object data of the at least one video object comprises a video stream and wherein the data preparation subsystem updates the video object by providing frame data for at least one new frame of the video stream.

7. The system of claim 5, wherein the one or more visual objects is comprised of at least one 3D object.

8. The system of claim 1, wherein the first and second communications ports are based on a wireless protocol, such that visual objects and instructions may be transmitted from the source device to the target device wirelessly.

9. The system of claim 1, wherein the one or more visual objects is comprised of at least one image object.

10. The system of claim 1, wherein the one or more visual objects is comprised of at least one video object.

11. The system of claim 10, wherein the object data of the at least one video object comprises a video stream and wherein the data preparation subsystem updates the video object by providing frame data for at least one new frame of the video stream.

12. The system of claim 1, wherein the one or more visual objects is comprised of at least one 3D object.

13. A source device for transmitting at least one media content to a target device comprising:
a processor;
a storage device coupled to the processor, comprising code, executable by the processor, for performing the steps of:
representing the media content as one or more elements, each element embodying a separate layer of the media content;
creating one or more visual objects, each object corresponding to one of the one or more elements, wherein each visual object comprises an object ID uniquely identifying the visual object, an object data comprising the visual data representative of the element, an XY position indicating the location on a user interface of the target device where the object data should be displayed, and a Z-order designation designating the element's layer with respect to the other elements of the media content, and wherein each visual object can be managed and updated independently;
providing one or more instructions to update the one or more visual objects; and
a communications port to transmit the one or more visual objects and the one or more instructions to the target device.

14. The source device of claim 13 further comprising a user interface configured to allow a user to initiate the transmission of the at least one media content to the target device.

15. The source device of claim 13, further comprising a user interface configured to allow a user to select the at least one media content for transmission to the target device.

16. The source device of claim 13, wherein the code, executable by the processor, comprises an operating system and one or more application programs configured to run on the operating system.

17. The source device of claim 16, wherein the one or more visual objects is comprised of at least one video object and at least one image object, and wherein the Z-order designations of the image object and the video object are such that the image object is displayed on top of the video object.

18. The source device of claim 17, wherein the at least one image object is a partially transparent image object.

19. The source device of claim 18, wherein the communication port is a wireless communication port.

20. The source device of claim 19, wherein the object data of the at least one video object comprises a video stream and wherein the instructions to update the video object comprise frame data for at least one new frame of the video stream.

21. The source device of claim 20, wherein the one or more visual objects is comprised of at least one 3D object.

22. The source device of claim 13, wherein the communications port transmits the one or more visual objects to the target device by transmitting a copy of the one or more visual objects to the target device.

23. The source device of claim 13, wherein the communication port transmits the one or more visual objects to the target device by transmitting instructions and data to enable the target device to create the visual objects.

24. The source device of claim 13, wherein the one or more visual objects is comprised of at least one image object.

25. The source device of claim 13, wherein the one or more visual objects is comprised of at least one video object.

26. The source device of claim 25, wherein the object data of the at least one video object comprises a video stream and wherein the instructions to update the video object comprise frame data for at least one new frame of the video stream.

27. The source device of claim 13, wherein the one or more visual objects is comprised of at least one 3D object.

28. A target device for the receipt and display of at least one media content comprising:
a communications port configured to receive one or more visual objects and one or more instructions to update the one or more visual objects, each visual object corresponding to an element embodying a separate layer of a media content and each visual object having an object ID, an object data, an XY position and a Z-order designation;
a visual object collection configured to store the one or more visual objects;
a visual object collection manager configured to manage the one or more visual objects, the visual object collection manager managing each visual object independently;
at least one visual data processor configured to process the object data of the one or more visual objects;
a Z-order processor to combine at least a subset of the one or more visual objects to recreate the media content for display; and
a display configured to present the recreated media content.

29. The target device of claim 28, wherein the visual object collection manager is further configured to execute the one or more instructions.

30. The target device of claim 28, wherein the communication port is a wireless communications port.

31. The target device of claim 30, wherein the one or more visual objects is comprised of at least one video object and at least one image object, and wherein the Z-order designations of the image object and the video object are such that the Z-order processor combines the objects such that the image object is presented on the display on top of the video object.

32. The target device of claim 31, wherein the at least one image object is a partially transparent image object.

33. The target device of claim 32, wherein the object data of the at least one video object comprises a video stream and wherein the instructions to update the video object comprise frame data for at least one new frame of the video stream.

34. The target device of claim 28, wherein the one or more visual objects is comprised of at least one video object.

35. The target device of claim 34, wherein the object data of the at least one video object comprises a video stream and wherein the instructions to update the video object comprise frame data for at least one new frame of the video stream.

36. A computer-implemented method for processing at least one media content on a source device for transmission to a target device, the method comprising the steps of:
representing the media content as one or more elements, each element embodying a separate layer of the media content;
creating one or more visual objects, each object corresponding to one of the one or more elements, wherein each visual object comprises an object ID uniquely identifying the visual object, an object data comprising the visual data representative of the element, an XY position indicating the location on a user interface of the target device where the object data should be displayed, and a Z-order designation designating the element's layer with respect to the other elements of the media content, and wherein each visual object can be managed and updated independently;
providing one or more instructions to update the one or more visual objects; and
transmitting the visual object for each of the one or more elements and the one or more instructions to the target device via a communications port.

37. The method of claim 36 further comprising the step of initiating the transmission of the at least one media content to the target device.

38. The method of claim 36 further comprising the step of selecting the at least one media content for transmission to the target device.

39. The method of claim 36, wherein the object data of the visual object of the one or more elements is an image.

40. The method of claim 39, wherein the image is partially transparent.

41. The method of claim 36, wherein the object data of the visual object of the one or more elements is at least one frame of a compressed video stream.

42. The method of claim 36, wherein the object data of the one or more elements is 3D data.

43. The method of claim 42, further comprising the step of transmitting 3D language commands to update the 3D data.

44. The method of claim 42, further comprising the step of transmitting marshaled function calls of a 3D API to update the 3D data.

45. The method of claim 44, wherein the 3D API is OpenGL.

46. The method of claim 44, wherein the 3D API is DirectX.

47. The method of claim 36, wherein the object ID is assigned by an application program.

48. The method of claim 47, wherein the application program represents the media content as one or more elements.

49. The method of claim 48, wherein the one or more visual objects is comprised of at least one video object and at least one image object, and wherein the Z-order designations of the image object and the video object are such that the image object is displayed on top of the video object.

50. The method of claim 49, wherein the at least one image object is a partially transparent image object.

51. The method of claim 50, wherein the communications port is a wireless communications port.

52. The method of claim 36, wherein the object ID is assigned by an operating system.

53. The method of claim 52, wherein the operating system represents the media content as one or more elements.

54. The method of claim 53, wherein the one or more visual objects is comprised of at least one video object and at least one image object, and wherein the Z-order designations of the image object and the video object are such that the image object is displayed on top of the video object.

55. The method of claim 54, wherein the at least one image object is a partially transparent image object.

56. The method of claim 55, wherein the communications port is a wireless communications port.

57. A method for receiving and displaying a media content on a target device comprising a communications port and a display, the method comprising the steps of:
receiving one or more visual objects on the target device via the communications port, each visual object having an object ID, an object data, an XY position and a Z-layer designation, wherein each visual object corresponds to an element of the media content, and wherein each visual object can be managed independently;
storing the visual objects in a memory;
for each of the one or more visual objects, processing the object data of the visual object;
combining the visual objects according to their respective Z-order designations to recreate the media content; and
presenting the recreated media content on the display.

58. The method of claim 57, wherein the one or more visual objects are stored in a visual object collection.

59. The method of claim 57, further comprising the step of receiving one or more instructions to update one or more of the visual objects via the communications port.

60. The method of claim 59, wherein the one or more visual objects comprises at least one video object, and wherein the one or more instructions comprises frame data for at least one frame of a video stream.

61. The method of claim 60 further comprising the step of updating at least one of the visual objects.

62. The method of claim 57, wherein the communication port is a wireless communications port.

63. The method of claim 57, wherein the step of processing the object data of the visual object is performed by one or more visual data processors.

64. The method of claim 63, wherein at least one of the one or more visual data processors is configured to decompress a compressed video stream.

65. The method of claim 57, wherein the step of combining the visual objects according to their respective Z-order designations is performed by one or more Z-order processors.

66. The method of claim 65, wherein the one or more visual objects is comprised of at least one video object and at least one image object, and wherein the Z-order designations of the image object and the video object are such that the Z-order processor combines the objects such that the image object is presented on the display on top of the video object.

67. The method of claim 66, wherein the at least one image object is a partially transparent image object.

68. The method of claim 66, wherein the Z-order processor performs double buffering.
